(19) United States
(12) Patent Application Publication
(10) Pub. No.: US 2010/0188708 A1
(43) Pub. Date: Jul. 29, 2010

(54) Method to utilize non-image area in image reproduction

(76) Inventor: Terry R. Ham, Royal Palm Beach, FL (US)

Correspondence Address: Terry Ham, 1567 Fiddlewood Ct., Royal Palm Beach, FL, 33411, US

(21) Appl. No.: 12/798,070

(22) Filed: Mar. 29, 2010

Related U.S. Application Data
(63) Continuation-in-part of application No. 11/560,747, filed on Nov. 16, 2006.

(51) Int. Cl. H04N 1/405

(52) U.S. Cl. 358/3.06

(57) ABSTRACT

The method conceptually applies a new halftone dot, here after referred to as the T-Dot, to raster images in the process of screening, where a bitmap of continuous tone is converted into a pattern of dots or halftone. In preparing an image to be printed, the method will adjust the surface area of the T-Dot by creating a non-image area inside of the T-Dot. The method facilitates precise control over the area of the printed halftone dot.

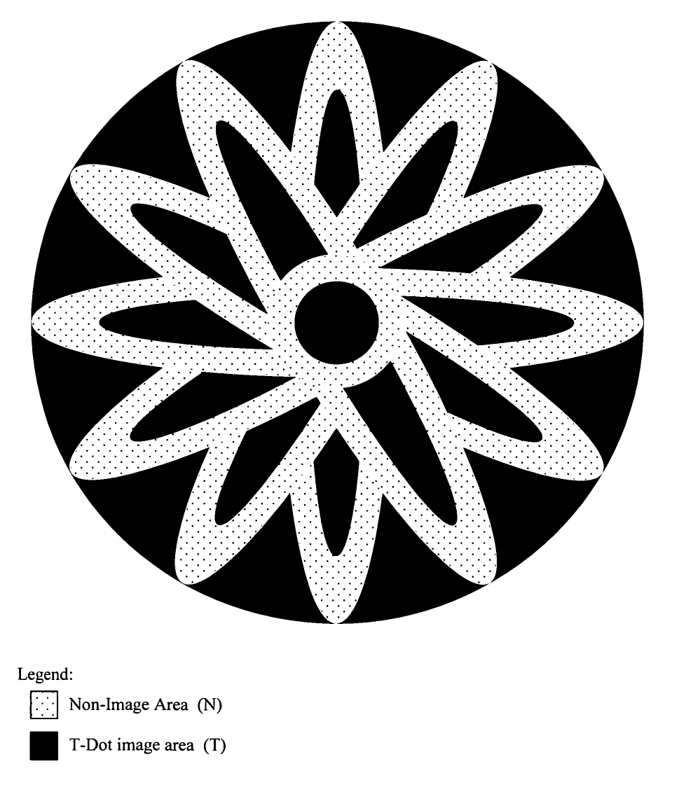

The following specification is a continuation-in-part for application Ser. No. 11/560,747.

### CROSS-REFERENCE TO RELATED APPLICATIONS

Not Applicable

### FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

While there are many techniques for reproducing images in color, specific graphic processes and industrial equipment are used for mass reproduction of color images on paper. In the commercial printing industry, four-color process printing is universally used for the reproduction of color images.

Four-color process printing is a system where a color image is separated into 4 different color values (color separation) by the use of filters and screens. The result is a color separation of 4 images that when transferred to printing plates and sequentially printed on a printing press with the colored inks cyan (blue), magenta (red), yellow and black, reproduces the original color image.

Two graphic techniques are required to prepare images for four-color process printing. In the “pre-press” stage, original images are translated into forms that can be used on a printing press, through “color separation,” and “screening” or “halftoning.” These steps make possible the creation of printing plates that can transfer color impressions to paper on printing presses based on the principles of lithography.

In process color printing, the screened image, or halftone for each ink color is printed in succession. The screen grids are set at different angles, and the dots therefore create tiny rosettes to form a continuous-tone image. As ink is applied to paper, the elementary halftone dots used in printing grow larger. The measure of how much an ink dot spreads and becomes larger on paper is called dot gain. This phenomenon must be accounted for in digital preparation of screened images. Dot gain is higher on more absorbent, uncoated paper stock such as newsprint.

### BRIEF SUMMARY OF THE INVENTION

The method applies a completely new halftone dot, the T-Dot, at the raster imaging processor (RIP) or imaging computer in computer to plate (CTP) applications for Process Printing. The size of a halftone dot cannot be adjusted for dot gain on the press without losing detail, shadows and highlights. Instead, the method will adjust the surface area of the T-Dot. Within the interior of each T-Dot, a non-image area is applied using a mathematical formula.

The non-image area within each T-Dot is utilized to harness the natural dot gain inherent to Four Color Process printing. The natural dot gain that occurs on press during the printing process will fill in the non-image area inside of the T-Dot. The method facilitates precise control over the area of the printed halftone dot.

### BRIEF DESCRIPTION OF THE SEVERAL VIEWS OF THE DRAWING

The drawing is an example of a T-dot wherein there is a non-image area (N) inside of the T-Dot. The non-image area (N) inside of the T-Dot is slightly screened in the drawing to illustrate that it is different from the background non-image area of a conventional halftone screen.

### DETAILED DESCRIPTION OF THE INVENTION

Images to be reproduced on newsprint are sent from computer workstation through a Raster Image Processor (RIP) where the image is prepared for printing. The RIP settings determine a number of the individual parameters used for printing on newsprint including: line screens, screen angles, dot shape, and other characteristics of the image. In computer to plate (CTP) applications, the image is output through an imager where the halftones are electronically generated directly on the printing plate with a laser.

Halftone dots used in the reproduction process are used in many deferent frequencies, shapes and sizes. To date, however, all of these halftone dots have a single common characteristic; they are all one solid and continuous form.

The method embodies an improvement to the process by applying a T-Dot to the raster image that is generated on to the printing plate. Within each T-dot, non-image areas are applied using a mathematical formula. The method will adjust the surface area of the T-dot without a significant change in dot size and facilitate precise control over the area of the printed halftone dot.

As ink is applied to a substrate, the natural “dot gain” that occurs during the printing process will fill in the non-image area of the T-dot. Thus the non-image areas within each T-dot are utilized to harness the natural dot gain inherent to the printing process.

Newspaper printing is an example of the significant amount of dot gain inherent in the printing process. Currently, in the United States, the industry standard assumes dot gain of 30%. A=πr² is the mathematical formula for area. Therefore, A dot with a diameter of 0.010 thousands has an area of 78.5 square thousands. After 30% dot gain the area of this dot becomes 102.05 square thousands and the diameter has grown to 0.0114 thousands.

In theory, an image that requires a 50% screen should cover 50% of the printed area. However, with a process in which 30% dot gain is realized, 65% of the printed area is actually covered with ink. The quality of image reproduction in printing newspapers suffers because of the “muddied” or “plugged” screens caused by the 30% dot gain.

Newspapers today use a number of methods in an effort to control dot gain. Various dot shapes, tone curves, and press profiles are used in an attempt to solve this problem. To some degree these methods help to minimize dot gain, however the screens still become “plugged.” Current methods of compensating for dot gain cannot eliminate the negative effects of dot gain without causing other image quality problems.

Prepress application of the T-Dot at the RIP or imaging computer will adjust the surface area of the dot without significant change in dot size. The natural dot gain that occurs during printing will fill in the non-image areas of the dot. This will significantly reduce the printing dot's growth in size.

Within each dot, non-image areas are applied using a mathematical formula. The exact shape and size of the non-image areas would be determined for each individual application, however, it is recommended that the non-image areas be dispersed evenly within the dot using geometric shapes. To return a dot to the original size after 30% dot gain; it must first have the image area inside the dot reduced by 23%.

| | | |
|---|---|---|
| For example: | A = 78.5 st | |
| | Knock out 23% (N) | 18.055 st |
| | T = 60.445 st | |
| | Apply 30% dot gain (G) | 18.1335 st |

T · G = 78.5785 st = Area of Printed Dot

The method to utilize non-image areas in image reproduction is the first and only method that employees non-image areas within the elementary dot. It represents a fundamental change in approach to the phenomenon of dot gain. Linear to paper reproduction is achieved using the method. It also becomes possible to build graduation curves directly into the dot definition. The quality of image reproduction will be greatly enhanced with more clarity and higher resolution.

I claim:

1. A method of processing a raster image to facilitate linear to paper printing, wherein the area of a printed halftone dot is unchanged from the area of the corresponding halftone dot in the raster image, the steps comprising:
The halftone image to be printed is converted to a T-Dot image before it is transferred to a printing plate, wherein,
Segments of surface area are deleted from the interior of an elementary halftone dot forming a T-Dot.
The method as contained in claim 1 wherein the surface area of the elementary halftone dot is a known value (A) given the radius of the dot. {π·r²}
The method as contained in claim 1 wherein the deleted segment of surface area is assigned the value (N).
The method as contained in claim 1 wherein the remaining surface area is assigned the value (T).
The method as contained in claim 1 wherein the dot gain for a print application is assigned the value (G).
The method as contained in claim 1 wherein the surface area of the printed dot is assigned the value (P).
The method as contained in claim 1 wherein the surface area (T) is expressed by the formula [T=A−(A÷G)]
The value of (N) is determined by the formula [A−T=N]
Wherein:
A−N=T
and
T·G=P; A=P
